(19) United States
(12) Patent Application Publication
(10) Pub. No.: US 2026/0288339 A1
(43) Pub. Date: Sep. 24, 2026

(54) MEMORY SYSTEM AND CONTROL METHOD

(71) Applicant: Kioxia Corporation, Tokyo (JP)

(72) Inventors: Reina NISHINO, Yokohama Kanagawa (JP); Yohei HASEGAWA, Fuchu Tokyo (JP); Tetsuya SUNATA, Yokohama Kanagawa (JP); Takumi FUJIMORI, Yamato Kanagawa (JP)

(21) Appl. No.: 19/324,801

(22) Filed: Sep. 10, 2025

(30) Foreign Application Priority Data
Mar. 24, 2025 (JP) 2025-048412

(51) Int. Cl. G06F 3/06

(52) U.S. Cl. CPC G06F 3/0613; G06F 3/0659; G06F 3/0689

(57) ABSTRACT

A memory system includes a nonvolatile memory, a host interface, and a controller. The nonvolatile memory includes a first memory region. The host interface is connectable to a host and configured to receive mirroring information from the host. The controller is configured to maintain patrol cycle information indicating a patrol cycle with respect to an identifier of each of two or more mirroring regions, with respect to each of different numbers of mirroring regions. The controller is configured to, upon receiving the mirroring information from the host via the host interface, set a patrol cycle for the first memory region with reference to a part of the patrol cycle information corresponding to the mirroring information from the host, and perform a patrol process with respect to the first memory region at the set patrol cycle.

### CROSS-REFERENCE TO RELATED APPLICATION

This application is based upon and claims the benefit of priority from Japanese Patent Application No. 2025-048412, filed Mar. 24, 2025, the entire contents of which are incorporated herein by reference.

### FIELD

Embodiments described herein relate generally to a memory system and a control method.

### BACKGROUND

Memory systems that include nonvolatile memories with multiple memory cells are widespread. Such memory systems may execute a patrol process for sequentially reading data from a plurality of memory cells storing the data. In the memory systems, efficient execution of the patrol process is desired.

### BRIEF DESCRIPTION OF THE DRAWINGS

FIG. 1 is a diagram showing a hardware configuration of an information processing system including a memory system according to a first embodiment.

FIG. 2 is a diagram showing a configuration of a memory cell array in the first embodiment.

FIG. 3 is a diagram showing a functional configuration of a storage controller and the memory system in the first embodiment.

FIG. 4 is a diagram showing a data structure of patrol cycle management information in the first embodiment.

FIG. 5 is a sequence diagram showing an operation of the information processing system including the memory system according to the first embodiment.

FIG. 6 is a timing diagram showing an operation of the information processing system including the memory system according to the first embodiment.

FIG. 7 is a diagram showing a data structure of patrol cycle management information in a second embodiment.

FIG. 8 is a sequence diagram showing an operation of an information processing system including a memory system according to the second embodiment.

FIG. 9 is a timing diagram showing an operation of the information processing system including the memory system according to the second embodiment.

FIG. 10 is a diagram showing a configuration and an operation of an information processing system including a memory system according to a third embodiment.

FIG. 11 is a timing diagram showing an operation of the information processing system including the memory system according to the third embodiment.

FIGS. 12A and 12B are a diagram showing a configuration and an operation of an information processing system including a memory system according to a fourth embodiment.

FIGS. 13A and 13B are a diagram showing a configuration and an operation of an information processing system including a memory system according to a fifth embodiment.

FIG. 14 is a timing diagram showing a configuration and an operation of an information processing system including a memory system according to a sixth embodiment.

FIG. 15 is a diagram showing a data structure of block group management information in a seventh embodiment.

FIG. 16 is a diagram showing a data structure of patrol cycle management information in the seventh embodiment.

FIGS. 17A and 17B are a diagram showing a data structure of block group management information and a data structure of block management information in an eighth embodiment.

### DETAILED DESCRIPTION

Embodiments provide a memory system and a control method capable of efficiently executing a patrol process.

In general, according to an embodiment, a memory system includes a nonvolatile memory, a host interface, and a controller. The nonvolatile memory includes a first memory region. The host interface is connectable to a host and configured to receive mirroring information from the host, the mirroring information indicating: i) a number of mirroring regions assigned by the host for performing a mirroring operation to redundantly store data in the first memory region and a second memory region that is within or out of the memory system; and ii) an identifier of a mirroring region assigned to the first memory region. The controller is configured to maintain patrol cycle information indicating a patrol cycle with respect to an identifier of each of two or more mirroring regions, with respect to each of different numbers of mirroring regions, upon receiving the mirroring information from the host via the host interface, set a patrol cycle for the first memory region with reference to a part of the patrol cycle information corresponding to the number of mirroring regions and the identifier indicated by the mirroring information from the host, and perform a patrol process with respect to the first memory region at the set patrol cycle, the patrol process comprising reading of data from the first memory region and then writing of the read data into the first memory region after error correction included in the read data.

The memory system and the control method according to embodiments will be described in detail below with reference to the accompanying drawings. It is noted that the present disclosure is not limited to these embodiments.

### First Embodiment

A memory system according to a first embodiment includes a nonvolatile memory that is provided with a memory cell array including a plurality of memory cells. The memory system according to the first embodiment executes a patrol process to read data from the plurality of memory cells in sequence, and measures are implemented for the efficient execution of the patrol process.

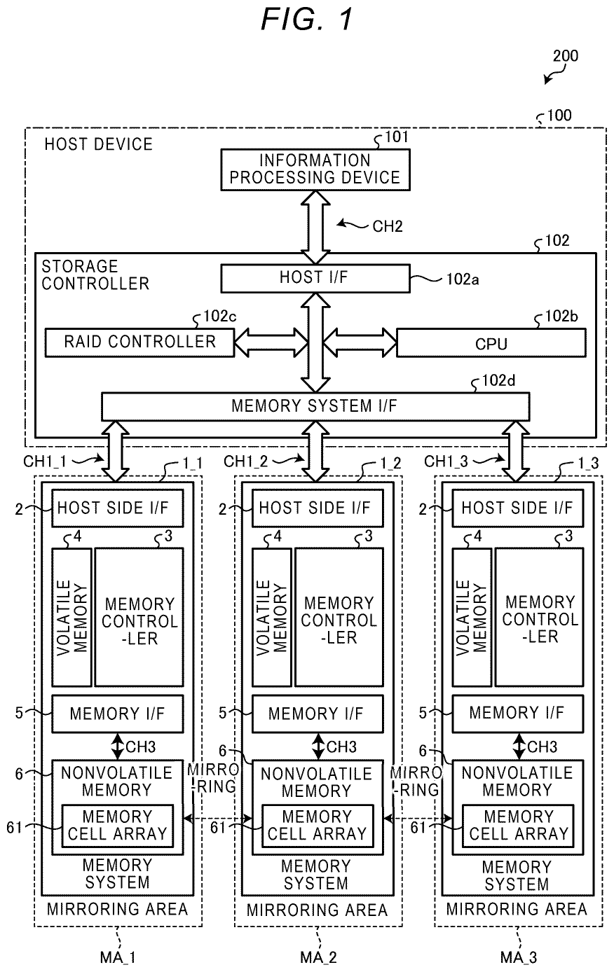

An information processing system 200 including a memory system 1 according to the first embodiment may be configured as shown in FIG. 1. FIG. 1 is a diagram showing a configuration of the information processing system 200 including the memory system 1.

The information processing system 200 includes a host device 100 and a plurality memory systems 1_1 to 1_3. Each of the memory systems 1 is connected externally to the host device 100 via a communication medium CH1 and serves as an external storage medium for the host device 100. Each memory system 1 includes, for example, a Solid State Drive (SSD).

The host device 100 includes an information processing device 101 and a storage controller 102. The information processing device 101 is an upper-level device of the storage controller 102. The information processing device 101 includes, for example, a personal computer or a CPU core.

The storage controller 102 includes a host interface (host I/F) 102a, a CPU 102b, a Redundant Arrays of Inexpensive Disks (RAID) controller 102c, and a memory system interface (memory system I/F) 102d. The host interface 102a, the CPU 102b, the RAID controller 102c, and the memory system interface 102d are communicatively connected to each other via a bus. The host interface 102a is communicatively connected to the information processing device 101 via a communication medium CH2. The memory system interface 102d is communicatively connected to the memory systems 1_1 to 1_3 via the communication media CH1_1 to CH1_3, respectively.

Each memory system 1 includes a host side interface (host side I/F) 2, a memory controller 3, a volatile memory 4, a memory interface (memory I/F) 5, and a nonvolatile memory. The host side interface 2 is communicatively connected to the storage controller 102 via the communication medium CH1. The host side interface 2, the memory controller 3, the volatile memory 4, and a memory interface 5 are communicatively connected to each other via a bus. The memory interface 5 is communicatively connected to a nonvolatile memory 6 via the channel CH3. The nonvolatile memory 6 includes a memory cell array 61.

The memory cell array 61 includes a plurality of blocks, and the memory controller 3 may manage data in units derived from the blocks (e.g., cluster units obtained by dividing a block into a plurality of segments).

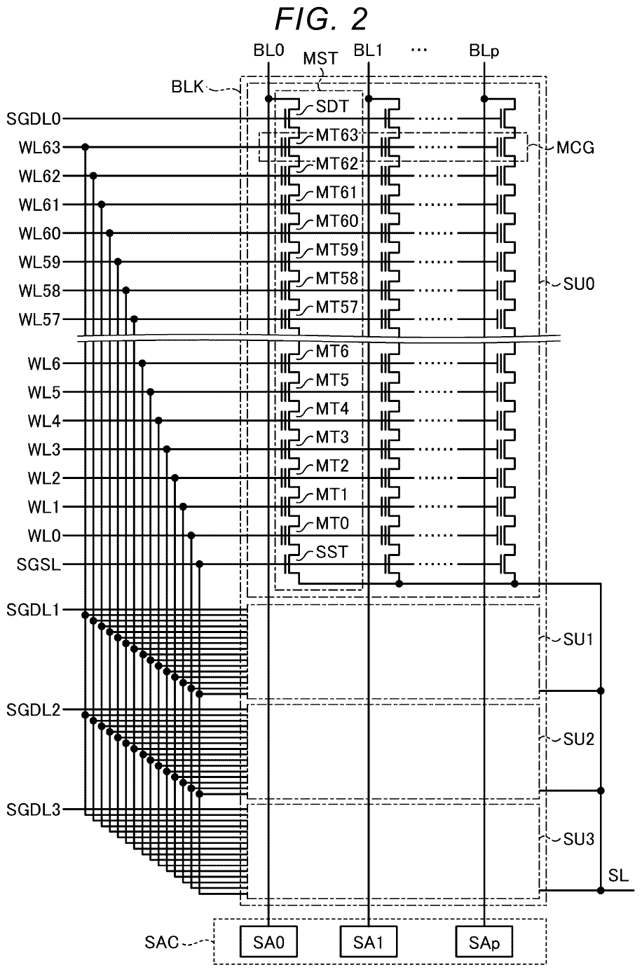

The block is a unit of data erasure. Each block includes memory cells at respective intersections of a plurality of word lines and a plurality of bit lines which are spaced apart from one another and intersect with one another. FIG. 2 is a circuit diagram showing an example configuration of one block.

A physical block BLK includes a plurality of string units SU0 to SU3. The plurality of string units SU0 to SU3 correspond to a plurality of select gate lines SGDL0 to SGDL3, respectively and share a select gate line SGSL. Each of the string units SU0 to SU3 serves as a drive unit in the physical block BLK. Each of the string units SU0 to SU3 may be driven by a corresponding select gate line SGDL of the plurality of select gate lines SGDL0 to SGDL3 and the select gate line SGSL. Each of the string units SU0 to SU3 also includes a plurality of memory strings MST.

Each of the memory strings MST includes, for example, 64 memory cell transistors MT (MT0 to MT63) and two select transistors SDT and SST. The plurality of memory strings MST are connected in parallel between a corresponding bit line BL of bit lines BL0 to BLp and one source line SL. The memory cell transistor MT includes a control gate and a charge storage film, and stores data in a nonvolatile manner. The 64 memory cell transistors MT (MT0 to MT63) are connected in series between a source of the select transistor SDT and a drain of the select transistor SST. The number of memory cell transistors MT in the memory string MST is not limited to 64.

Each of the bit lines BL0 to BLp (hereinafter simply referred to as BL when not distinguishing between individual bit lines) is connected to some of the plurality of memory strings MST. When the select transistor SDT is turned on, a channel region of each memory cell transistor MT in the memory string MST may be electrically connected to the bit line BL. Each bit line BL is connected to a corresponding sense amplifier SA of a plurality of sense amplifiers SA0 to SAp in a sense amplifier circuit SAC.

Word lines WL0 to WL63 (hereinafter simply referred to as WL when not distinguishing between individual word lines) commonly connect the control gates of the corresponding memory cell transistors MT between the memory strings MST in each string unit SU in the physical block BLK. In other words, the control gates of the memory cell transistors MT in the same line in each string unit SU in one physical block BLK are connected to the same word line WL. That is, each string unit SU includes a plurality of memory cell groups MCG corresponding to a plurality of word lines WL, and each memory cell group MCG includes (p+1) memory cell transistors MT connected to the same word line WL. When the system is configured to store 1-bit value in each memory cell transistor MT (operating in a single-level cell (SLC) mode), (p+1) memory cell transistors MT (i.e., memory group MCG) connected to the same word line WL are treated as one physical page. In this case, data write process and data read process are executed for each physical page.

Each memory cell transistor MT may be configured to store a multi-bit value. For example, when each memory cell transistor MT can store a n-bit value (n≥2), the storage capacity per word line WL is equal to the size of n physical pages. That is, each memory cell group MCG is treated as n physical pages. For example, in a multi-level cell (MLC) mode in which each memory cell transistor MT stores a 2-bit value, data for two physical pages are stored in each word line WL. Alternatively, in a triple-level cell (TLC) mode in which each memory cell transistor MT stores a 3-bit value, data for three physical pages are stored in each word line WL. Alternatively, in a quad-level cell (QLC) mode in which each memory cell transistor MT stores a 4-bit value, data for four physical pages are stored in each word line WL. Alternatively, in a penta-level cell (PLC) mode in which each memory cell transistor MT stores a 5-bit value, data for 5 physical pages are stored in each word line WL.

In addition, the memory cell array 61 includes a plurality of units accessible in parallel by the memory controller 3. The memory controller 3 manages, as one super page, a plurality of memory cell groups MCG that can perform write/read operations almost collectively in parallel, and manages, as one super block, a plurality of physical blocks BLK that can perform erase operations in parallel.

Further, the memory controller 3 manages data in the nonvolatile memory 6 by using a cluster which is a data management unit smaller than a page. For example, the cluster size is set to be at least as large as the size of a sector, which is the minimum access unit from a host device 100, and is managed so that the page size is a natural number multiple of the cluster size. For example, one page includes four clusters. For example, one super page may store data for 64 clusters.

In the configuration shown in FIG. 1, when the host side interface 2 receives a host write command from the host device 100, the memory controller 3 receives the host write command from the host side interface 2. In response to receiving the host write command, the host side interface 2 receives write data from the host device 100. The host write command includes a specification of a logical address. The memory controller 3 assigns a physical address corresponding to the logical address and writes the write data to the memory cell transistor MT specified by the physical address in the nonvolatile memory 6. In response to receiving a write completion notification from the nonvolatile memory 6, the memory controller 3 supplies the write completion notification to the host side interface 2. The host side interface 2 transmits the write completion notification to the host device 100.

When the host side interface 2 receives a host read command from the host device 100, the memory controller 3 receives the host read command from the host side interface 2. The host read command includes a specification of a logical address. The memory controller 3 assigns a physical address corresponding to the logical address and reads data from the memory cell transistor MT specified by the physical address in the nonvolatile memory 6. In response to receiving read data from the nonvolatile memory 6, the memory controller 3 supplies the data to the host side interface 2. The host side interface 2 transmits the read data to the host device 100.

As a technology for protecting data and improving its reliability, there is a patrol process using error detection and correction processing by Error Checking and Correction (ECC).

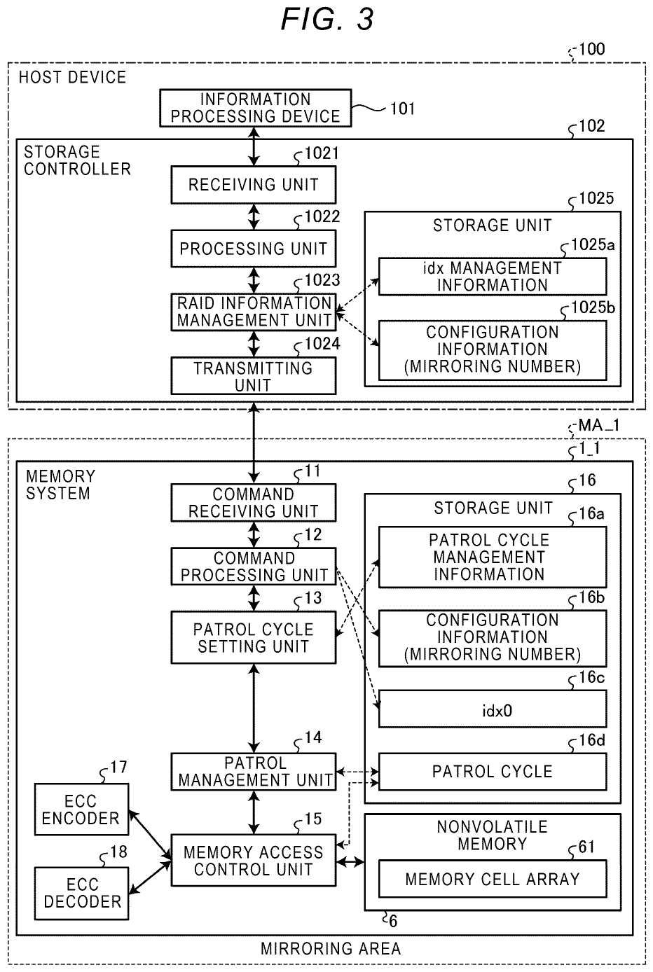

For example, when data is to be written to a plurality of memory cell transistors MT in the memory cell array 61, a code word with an error correction code added to the data is generated in an ECC encoder 17 (see FIG. 3) and the code word is written to the plurality of memory cell transistors MT.

The patrol process includes a patrol read operation and a refresh write operation. Each of the patrol read operation and the refresh write operation is a process not related to control by the host device 100, and is performed as an internal processing or background processing by the memory controller 3.

In the patrol read operation, code words are read as data from the plurality of memory cell transistors MT in order of physical addresses, for example, and then error detection is performed by an ECC decoder 18 (see FIG. 3) using the error correction code included in the code word. When an error bit in the data is detected, the ECC decoder 18 corrects the error bit using the error correction code.

In the refresh write operation, for the corrected data, a code word with the error correction code added to the corrected data is generated in the ECC encoder 17, and the code word is rewritten to the memory cell transistor MT at another physical address.

By this patrol process, the reliability of the data stored in the memory cell array 61 can be improved.

As another technology for protecting data and improving its reliability, a configuration for data redundancy protection, such as the so-called Redundant Arrays of Inexpensive Disks (RAID) 1 system, can be considered. In the RAID 1 system, mirroring is performed in which the same data is written redundantly to at least two storage devices. By the mirroring, for example, when data damage occurs in one of the two storage devices, the same data may be read from the other storage device to ensure fault tolerance and redundancy.

As shown in FIG. 1, a plurality of mirroring areas MA_1 to MA_3 are allocated in the information processing system 200. Each of the mirroring areas MA_1 to MA_3 is allocated to the memory systems 1_1 to 1_3, respectively.

The storage controller 102 controls a plurality of memory systems 1_1 to 1_3 as the RAID 1 system. The RAID 1 system may be a RAID 0+1 system. In case of the RAID 0+1 system (not shown), a plurality of memory systems 1 may be allocated to each mirroring area MA. For example, the storage controller 102 writes the same data redundantly to the plurality of memory systems 1_1 to 1_3. That is, the storage controller 102 performs mirroring by redundantly writing the same write data across the plurality of memory systems 1_1 to 1_3. The storage controller 102 may write the data to the plurality of memory systems 1_1 to 1_3 in parallel or in series.

For example, when the patrol process is being executed as background processing for a plurality of memory cell transistors MT addressed by the host write command or the host read command, the write process or the read process of the memory system 1 in response to the host write command or the host read command tends to cause a larger latency (in other words, the memory system 1 is heavily loaded), and performance degradation of the memory system 1 may occur.

To address such an issue, in the present embodiment, the memory system 1 is directed to differentiating the cycle for the patrol process in accordance with the configuration information about mirroring configuration and execute the patrol processes at the differentiated cycles, thereby reducing the load of the memory system 1 in performing the patrol process and preventing the performance degradation of the memory system 1.

The storage controller 102 and the memory system 1 may be functionally configured as shown in FIG. 3. FIG. 3 is a diagram showing a functional configuration of the storage controller 102 and the memory system 1.

The storage controller 102 includes a receiving unit 1021, a processing unit 1022, a RAID information management unit 1023, a transmitting unit 1024, and a storage unit 1025. The storage unit 1025 stores idx management information 1025a and configuration information 1025b.

In the storage controller 102, the receiving unit 1021 may receive a build request related to the RAID 1 system from the information processing device 101. The build request relates to building the mirroring. The receiving unit 1021 receives the build request and supplies the same to the processing unit 1022.

The processing unit 1022 processes the build request. The processing unit 1022 extracts a build instruction included in the build request and information about mirroring configuration. The build instruction instructs to execute an operation related to the mirroring. The information about configuration of the mirroring includes information about the number of mirroring areas MA (hereinafter referred to as a mirroring number).

The processing unit 1022 supplies the build instruction and the information about mirroring configuration to the RAID information management unit 1023.

In response to the build instruction, the RAID information management unit 1023 allocates the mirroring areas MA to the plurality of memory systems 1_1 to 1_3 under the management of the storage controller 102 and builds the RAID 1 system. The RAID information management unit 1023 allocates mirror indexes idx0, idx1, and idx2 to the plurality of memory systems 1_1, 1_2, and 1_3, respectively, and generates the idx management information 1025a. The idx management information 1025a is information in which an identifier of the memory system 1 and a mirror index idx are associated with the plurality of memory systems 1_1, 1_2, and 1_3. The RAID information management unit 1023 stores the idx management information 1025a in the storage unit 1025.

The RAID information management unit 1023 stores the information about mirroring configuration as the configuration information 1025b in the storage unit 1025. At the same time, the RAID information management unit 1023 issues a mirroring information notification command including the configuration information 1025b and information about mirror indexes idx0, idx1, and idx2, and supplies the issued command to the transmitting unit 1024.

The transmitting unit 1024 transmits the mirroring information notification command including the configuration information 1025b and information about a mirror index idx0 to the memory system 1_1. The transmitting unit 1024 transmits a mirroring information notification command including the configuration information 1025b and information about a mirror index idx1 to the memory system 1_2. The transmitting unit 1024 transmits a mirroring information notification command including the configuration information 1025b and information about a mirror index idx2 to the memory system 1_3.

The memory system 1_1 includes a command receiving unit 11, a command processing unit 12, a patrol cycle setting unit 13, a patrol management unit 14, a memory access control unit 15, a storage unit 16, the ECC encoder 17, the ECC decoder 18, and the nonvolatile memory 6. The storage unit 16 stores patrol cycle management information 16a, configuration information 16b, idx0 information 16c, and patrol cycle information 16d.

It is noted that while FIG. 3 illustrates an example of the functional configuration of the memory system 1_1, the configurations of the other memory systems 1_2 and 1_3 are similar to that of the memory system 1_1, except that the idx0 information 16c is replaced with idx1 information 16c and idx2 information 16c, and the patrol cycle information 16d is replaced with patrol cycle information 16d for the memory system 1_2 and patrol cycle information 16d for a memory system 1_3.

In the memory system 1_1, the command receiving unit 11 receives the mirroring information notification command including the configuration information 1025b and the mirror index idx0 from the storage controller 102. The command receiving unit 11 supplies the mirroring information notification command to the command processing unit 12.

The command processing unit 12 processes the mirroring information notification command. The command processing unit 12 extracts the configuration information 1025b and the mirror index idx0 included in the mirroring information notification command. The command processing unit 12 stores the configuration information 1025b as the configuration information 16b in the storage unit 16. The command processing unit 12 stores the mirror index idx0 as the idx0 information 16c in the storage unit 16.

The memory system 1_1 can access the storage unit 16, refer to the mirror index information 16c (=the mirror index idx0), and determine that the mirroring area MA_1 is allocated to the memory system 1_1. The memory system 1_1 may refer to the information about mirroring number included in the configuration information 1025b (e.g., the mirroring number =3) and determine that the data of the memory system 1_1 is mirrored with the two other memory systems 1_2 and 1_3. As a result, the RAID 1 system is built on the memory system 1_1 side.

At the same time, the command processing unit 12 supplies the configuration information 1025b and the mirror index information 16c to the patrol cycle setting unit 13.

In each of the memory systems 1_1, 1_2, and 1_3, the patrol cycle setting unit 13 creates common patrol cycle management information 16a and stores the same in the storage unit 16. The timing for creating the patrol cycle management information 16a may be before shipment of each memory system 1_1, 1_2, and 1_3, or may be at the timing when the configuration information 1025b and the mirror index information 16c are supplied from the command processing unit 12 after shipment.

In the patrol cycle management information 16a, the configuration information about mirroring, the mirror indexes, and the information about patrol cycle are associated with a plurality of combinations of configuration information and mirror indexes. The mirror index is an index for building the RAID 1 system, but in the present embodiment, it is also used as an index for determining the patrol cycle.

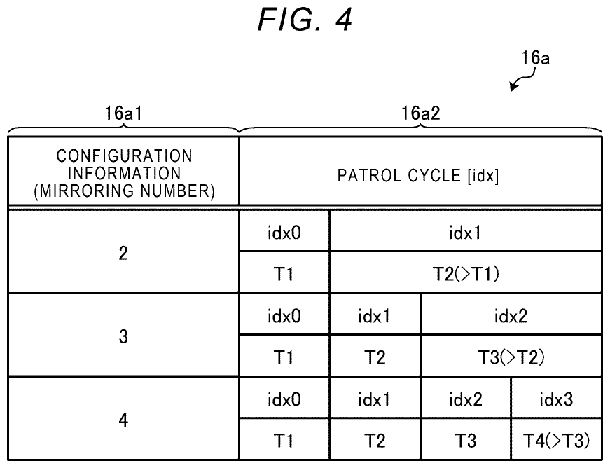

The patrol cycle management information 16a may be implemented in a table format as shown in FIG. 4. FIG. 4 is a diagram showing a data structure of the patrol cycle management information 16a.

The patrol cycle management information 16a shown in FIG. 4 includes a configuration information field 16a1 and an array field 16a2. In the configuration information field 16a1, the configuration information about mirroring is recorded. For example, the mirroring number is recorded. An array “patrol cycle [idx]” is recorded in the array field 16a2. The array “patrol cycle [idx]” is an array that returns a patrol cycle T when the mirror index idx is given.

By referring to the patrol cycle management information 16a, when the mirroring number is “2”, it can be seen that the patrol cycle for the mirror index idx0 is T1. It can be seen that the patrol cycle for the mirror index idx1 is T2 (>T1).

By referring to the patrol cycle management information 16a, when the mirroring number is “3”, it can be seen that the patrol cycle for the mirror index idx0 is T1 and the patrol cycle for the mirror index idx1 is T2. It can also be seen that the patrol cycle for the mirror index idx2 is T3 (>T2).

By referring to the patrol cycle management information 16a, when the mirroring number is “4”, it can be seen that the patrol cycle for the mirror index idx0 is T1, the patrol cycle for the mirror index idx1 is T2, and the patrol cycle for the mirror index idx2 is T3. It can also be seen that the patrol cycle for the mirror index idx3 is T4 (>T3).

The shortest patrol cycle T1 in the patrol cycle management information 16a may be a predetermined default patrol cycle to ensure data reliability of the memory system 1_1. Each of the other patrol cycles T2 to T4 may be an integer multiple of the patrol cycle T1.

In addition, the patrol cycle management information 16a may be implemented in a format other than the table format when the configuration information about mirroring, the mirror indexes, and the information about patrol cycle are associated with a plurality of combinations of configuration information and mirror indexes. The patrol cycle management information 16a may be implemented in a form of a function expression that returns a patrol cycle when the configuration information about mirroring and the mirror index are input. The information about patrol cycle may be provided as a difference from a default patrol cycle, rather than as a value of the patrol cycle itself.

In the memory system 1_1 shown in FIG. 3, the patrol cycle setting unit 13 receives the configuration information 1025b and the mirror index information 16c (=idx0) from the command processing unit 12. The patrol cycle setting unit 13 sets the cycle for patrol process according to the configuration information 1025b and the mirror index information 16c. The configuration information 1025b includes information about mirroring number.

The patrol cycle setting unit 13 accesses the storage unit 16, refers to the patrol cycle management information 16a, and determines a patrol cycle as T1 according to the mirroring number included in the configuration information 1025b (in this example, 3) and the mirror index idx0 indicated by the mirror index information 16c. The patrol cycle setting unit 13 supplies information about patrol cycle T1 to the patrol management unit 14.

The patrol management unit 14 generates the patrol cycle information 16d including the information about patrol cycle T1 and stores the generated information in the storage unit 16. Consequently, T1 is set as a patrol cycle for the memory system 1_1. The patrol management unit 14 may notify the memory access control unit 15 that the patrol cycle is set to T1.

The memory access control unit 15 accesses the storage unit 16, refers to the patrol cycle information 16d, and executes the patrol process on the nonvolatile memory 6 at the patrol cycle T1. The memory access control unit 15 may execute the patrol process on the nonvolatile memory 6 at the patrol cycle T1 according to a notification from the patrol management unit 14.

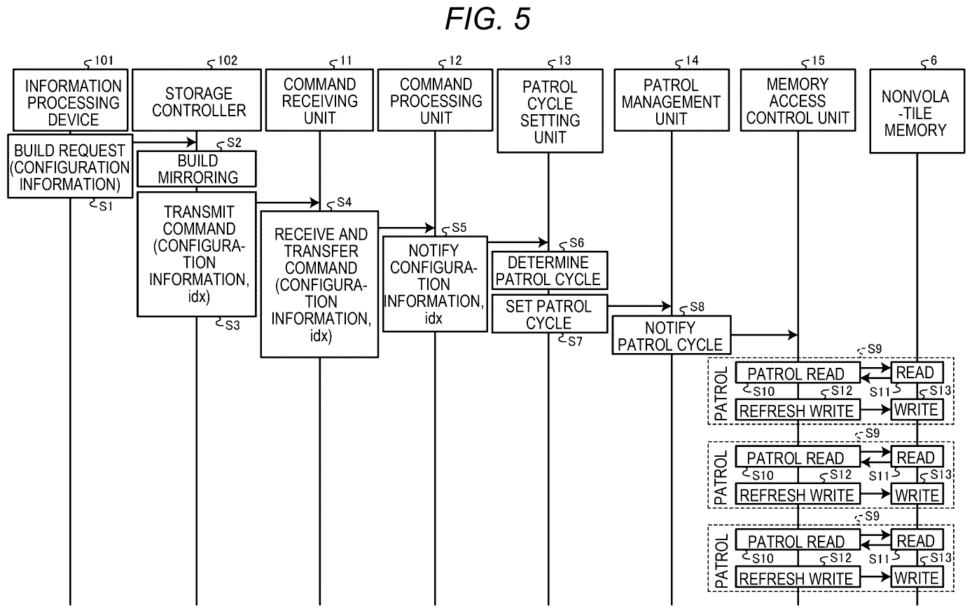

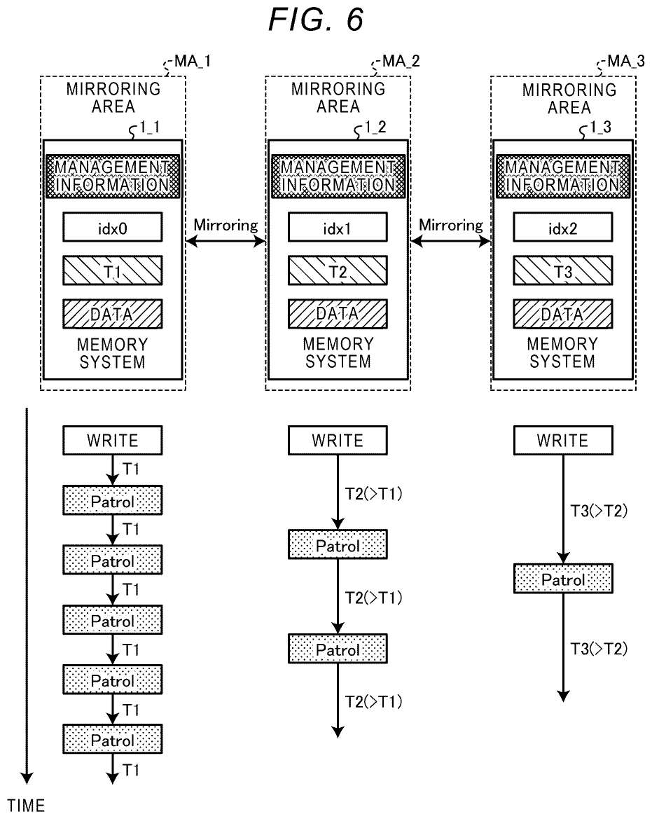

Next, the operation of the information processing system 200 will be described with reference to FIGS. 5 and 6. FIG. 5 is a sequence diagram showing the operation of the information processing system 200. FIG. 6 is a timing diagram showing the operation of the information processing system 200.

As shown in FIG. 5, when it is time to build the RAID 1 system, the information processing device 101 issues a build request and transmits the request to the storage controller 102 (S1). The build request includes the information about mirroring configuration as the configuration information. The configuration information includes the mirroring number.

In response to receiving the build request, the storage controller 102 builds a configuration for mirroring as part of building the RAID 1 system (S2). For example, when the mirroring number included in the configuration information is “3”, the storage controller 102 allocates mirror indexes idx0 to idx2 to three memory systems 1_1 to 1_3, respectively.

The storage controller 102 transmits mirroring information notification commands including the configuration information for the memory systems 1_1 to 1_3 and the information about mirror indexes idx0 to idx2 to the memory systems 1_1 to 1_3, respectively (S3).

In each of the memory systems 1_1 to 1_3, when a mirroring information notification command is received, the command receiving unit 11 transfers the mirroring information notification command to the command processing unit 12 (S4).

The command processing unit 12 extracts the configuration information and the information about mirror indexes idx0 to idx2 included in the mirroring information notification command. The command processing unit 12 notifies the patrol cycle setting unit 13 of the configuration information and the information about mirror indexes idx0 to idx2 (S5).

The patrol cycle setting unit 13 determines the patrol cycle according to the configuration information and the mirror index idx (S6). The patrol cycle setting unit 13 refers to the patrol cycle management information 16a, determines the patrol cycle T corresponding to the mirroring number included in the configuration information and its own mirror index idx, and sets the determined cycle in the patrol management unit 14 (S7). The set patrol cycle T differs among the plurality of memory systems 1_1 to 1_3.

The patrol management unit 14 notifies the memory access control unit 15 of the patrol cycle T set by the patrol cycle setting unit 13 (S8).

Accordingly, the memory access control unit 15 executes the patrol process at the patrol cycle T (S9).

In the patrol process (S9), the memory access control unit 15 issues a patrol read command and supplies the same to the nonvolatile memory 6 (S10).

In response to the patrol read command, the nonvolatile memory 6 reads the code words as data from the plurality of memory cell transistors MT in order of physical address (S11), and returns the read code words to the memory access control unit 15.

The memory access control unit 15 causes the ECC decoder 18 to perform error detection using the error correction code included in the code word. When a bit error in the data is detected, the ECC decoder 18 corrects an error bit using the error correction code.

In response to the correction of the error bit, the ECC encoder 17 generates a code word with the error correction code added to the corrected data for the corrected data. The memory access control unit 15 issues a refresh write command including the code word and supplies the same to the nonvolatile memory 6 (S12).

In response to the refresh write command, the nonvolatile memory 6 rewrites the code word to the memory cell transistor MT at another physical address (S13). After that, the same patrol process (S9) is repeatedly executed.

This patrol process (S9) is repeatedly executed at different patrol cycles T among the plurality of memory systems 1_1 to 1_3, as shown in FIG. 6.

The patrol cycles T1, T2, and T3 are set for the memory systems 1_1, 1_2, and 1_3 according to the mirror indexes idx0, idx1, and idx2, respectively.

First, the memory systems 1_1, 1_2, and 1_3 write the same data in the nonvolatile memory 6. As a result, the mirroring is completed and the RAID 1 system is built.

After mirroring is completed, the memory system 1_1 executes a patrol process at each patrol cycle T1 which is a default patrol cycle. Therefore, the reliability of data protection by the patrol process can be ensured in the memory system 1_1.

After mirroring is completed, the memory system 1_2 executes the patrol process at each patrol cycle T2 which is longer than the default. As a result, in the memory system 1_2, the frequency of patrol process is reduced from that of the memory system 1_1, and the load of patrol process is reduced. At this time, although the reliability of data protection by the patrol process may decrease, the reliability of data protection can be ensured because the same data is mirrored with the other memory systems 1_1 and 1_3.

After mirroring is completed, the memory system 1_3 executes the patrol process at each patrol cycle T3 which is longer than the default. As a result, in the memory system 1_3, the frequency of patrol process is further reduced than that of the memory systems 1_1 and 1_2, and the load of patrol process is further reduced. At this time, although the reliability of data protection by the patrol process may further decrease, the reliability of data protection can be ensured because the same data is mirrored with the other memory systems 1_1 and 1_2.

As described above, in the first embodiment, the memory system 1 sets the cycle for patrol process according to the configuration information about mirroring configuration and executes the patrol process at the set cycle. As a result, since the load of patrol process can be reduced in the memory system 1, the increase in the load of the write process or read process in the memory system 1 due to the patrol process can be prevented, and the performance degradation of the memory system 1 can be easily prevented.

### Second Embodiment

Next, a memory system according to a second embodiment will be described. Hereinafter, the differences from the first embodiment will be mainly described.

In the first embodiment, the example is illustrated in which the patrol cycle is set fixedly for each memory system 1, but in the second embodiment, an example will be illustrated in which the patrol cycle is set in a rotational manner for each memory system 1.

For example, the storage unit 16 of each memory system 1 may store the patrol cycle management information 16ai instead of the patrol cycle management information 16a (see FIG. 4). In patrol cycle management information 16ai, configuration information about mirroring, mirror indexes, and information about rotation of patrol cycles are associated with a plurality of combinations of configuration information and mirror indexes.

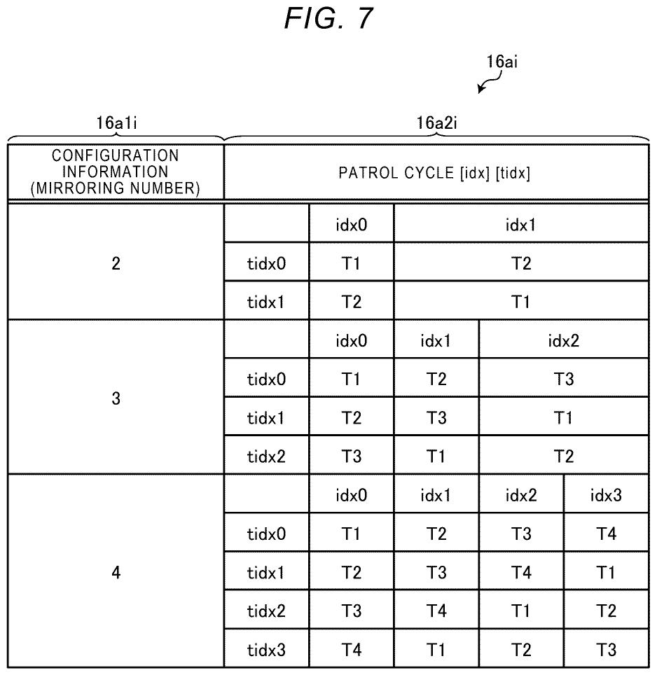

The patrol cycle management information 16ai may be implemented in a table format as shown in FIG. 7. FIG. 7 is a diagram showing a data structure of the patrol cycle management information 16ai in the second embodiment.

The patrol cycle management information 16ai shown in FIG. 7 includes a configuration information field 16a1i and an array field 16a2i. In the configuration information field 16a1i, the configuration information about mirroring is recorded. For example, the mirroring number is recorded. An array “patrol cycle [idx] [tidx]” is recorded in the array field 16a2i. The array “patrol cycle [idx] [tidx]” is an array that returns a patrol cycle T when the mirror index idx and the cycle index tidx are given. The cycle index tidx is an index for managing the rotation of patrol cycles.

By referring to the patrol cycle management information 16ai, it can be seen that when the mirroring number is “2”, the patrol cycle for the mirror index idx0 is rotated as T1→T2→T1. In addition, it can be seen that the patrol cycle for the mirror index idx1 is rotated as T2→T1→T2.

By referring to the patrol cycle management information 16ai, it can be seen that when the mirroring number is “3”, the patrol cycle for the mirror index idx0 is rotated as T1→T2→T3→T1. It can be seen that the patrol cycle for the mirror index idx1 is rotated as T2→T3→T1→T2. In addition, it can be seen that the patrol cycle for the mirror index idx2 is rotated as T3→T1→T2→T3.

By referring to the patrol cycle management information 16ai, it can be seen that when the mirroring number is “4”, the patrol cycle for the mirror index idx0 is rotated as T1→T2→T3→T4→T1. It can be seen that the patrol cycle for the mirror index idx1 is rotated as T2→T3→T4→T1→T2. It can be seen that the patrol cycle for the mirror index idx2 is rotated as T3→T4→T1→T2→T3. In addition, it can be seen that the patrol cycle for the mirror index idx3 is rotated as T4→T1→T2→T3→T4.

The shortest patrol cycle T1 in the patrol cycle management information 16ai may be a predetermined default patrol cycle to ensure data reliability of the memory system 1_1. Each of the other patrol cycles T2 to T4 may be an integer multiple of the patrol cycle T1.

In addition, the patrol cycle management information 16ai may be implemented in a format other than the table format when the configuration information about mirroring, the mirror indexes, and the information about rotation of patrol cycles are associated with a plurality of combinations of configuration information and mirror indexes. The patrol cycle management information 16ai may be implemented in a form of a function expression that returns the information about rotation of patrol cycles when the configuration information about mirroring and the mirror index are input. The information about rotation of patrol cycles may be information about rotation of differences relative to a default patrol cycle, instead of the information about rotation of patrol cycles.

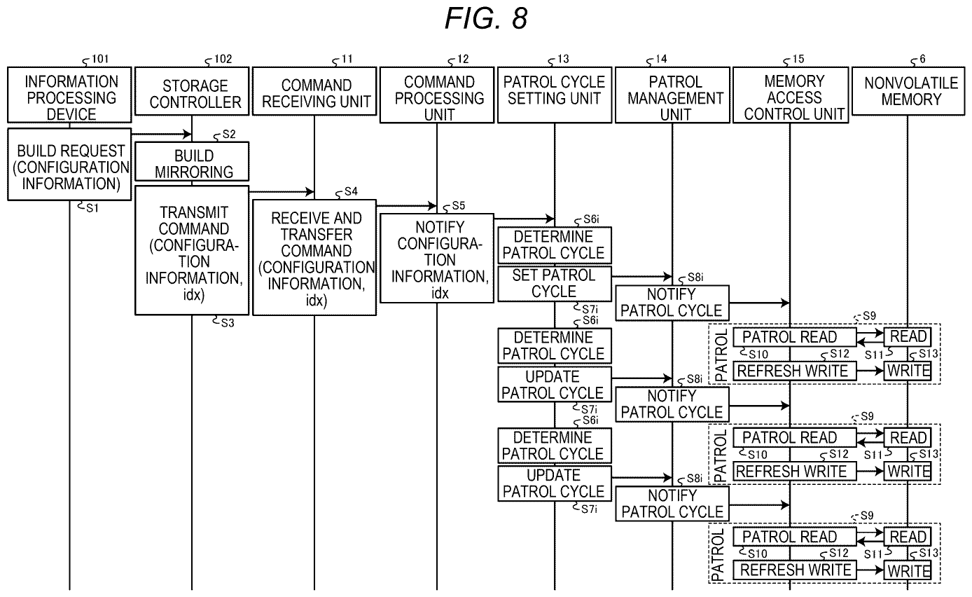

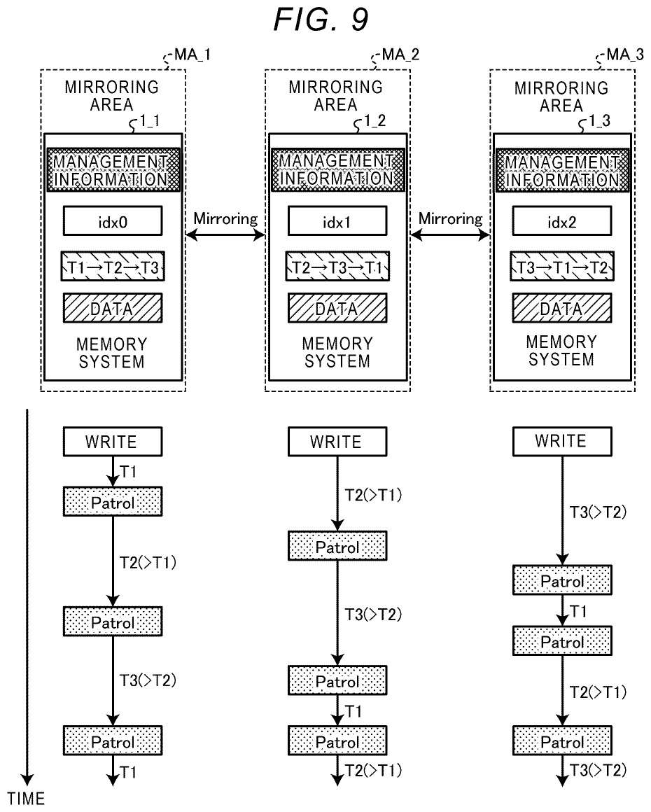

In addition, the operation of the information processing system 200 is different from that of the first embodiment in the following points, as shown in FIGS. 8 and 9. FIG. 8 is a sequence diagram showing an operation of the information processing system 200 including the memory system 1 according to the second embodiment. FIG. 9 is a timing diagram showing the operation of the information processing system 200 including the memory system 1 according to the second embodiment.

As shown in FIG. 8, after S1 to S5 is executed in the same way as the first embodiment, the patrol cycle setting unit 13 sets a cycle index tidx0 for the first patrol process and determines the patrol cycle according to the configuration information, the mirror index idx, and the cycle index tidx0 (S6i). The patrol cycle setting unit 13 refers to the patrol cycle management information 16ai, determines a patrol cycle Ti (e.g., Ti=T1) corresponding to the mirroring number included in the configuration information, its own mirror index idx, and the cycle index tidx0, and sets it in the patrol management unit 14 (S7i).

The patrol management unit 14 notifies the memory access control unit 15 of the patrol cycle Ti set by the patrol cycle setting unit 13 (S8i).

Accordingly, the memory access control unit 15 executes the patrol process at the patrol cycle Ti (S9).

After a first patrol cycle (S7i) is executed, the patrol cycle setting unit 13 sets a cycle index tidx1 for a second patrol process, and determines the patrol cycle according to the configuration information, the mirror index idx, and the cycle index tidx1 (S6i). The patrol cycle setting unit 13 refers to the patrol cycle management information 16ai, determines a patrol cycle Ti (e.g., Ti=T2) corresponding to the mirroring number included in the configuration information, its own mirror index idx, and the cycle index tidx1, and sets it in the patrol management unit 14 (S7i).

The patrol management unit 14 notifies the memory access control unit 15 of the patrol cycle Ti set by the patrol cycle setting unit 13 (S8i).

Accordingly, the memory access control unit 15 executes the patrol process at the patrol cycle Ti (S9).

After the second patrol cycle (S7i) is executed, the patrol cycle setting unit 13 sets a cycle index tidx2 for a third patrol process and determines the patrol cycle according to the configuration information, the mirror index idx, and the cycle index tidx1 (S6i). The patrol cycle setting unit 13 refers to the patrol cycle management information 16ai, determines a patrol cycle Ti (e.g., Ti=T3) corresponding to the mirroring number included in the configuration information, its own mirror index idx, and the cycle index tidx2, and sets it in the patrol management unit 14 (S7i).

The patrol management unit 14 notifies the memory access control unit 15 of the patrol cycle Ti set by the patrol cycle setting unit 13 (S8i).

Accordingly, the memory access control unit 15 executes the patrol process at the patrol cycle Ti (S9).

In addition, the patrol process (S9) is repeatedly executed with a rotation of different patrol cycles T among the plurality of memory systems 1_1 to 1_3, as shown in FIG. 9.

In the memory systems 1_1, 1_2, and 1_3, patrol cycle rotations T1→T2→T3→T1, T2→T3→T1→T2, and T3→T1→T2→T3 are set in accordance with the mirror indexes idx0, idx1, and idx2, respectively.

First, the memory systems 1_1, 1_2, and 1_3 write the same data in the nonvolatile memory 6. As a result, the mirroring is completed and the RAID 1 system is built.

After mirroring is completed, the memory system 1_1 executes the patrol process with a patrol cycle rotation of T1→T2→T3→T1.

After mirroring is completed, the memory system 1_2 executes the patrol process with a patrol cycle rotation of T2→T3→T1→T2.

After mirroring is completed, the memory system 1_3 executes the patrol process with a patrol cycle rotation of T3→T1→T2→T3.

As a result, the frequency of patrol process is equalized among the memory systems 1_1, 1_2, and 1_3, and the load of patrol process is equalized. Accordingly, the product lifetime of each memory system 1_1, 1_2, and 1_3 can be prolonged.

As described above, in the second embodiment, the memory system 1 sets the cycle for patrol process in a rotational manner according to the configuration information about mirroring configuration and executes the patrol process at the set cycle. As a result, in the memory system 1, the load of the patrol process can be reduced, and the load of the patrol process can be equalized among the memory systems 1. As a result, the performance degradation of the memory system 1 can be easily prevented, and the product lifetime of the memory system 1 can be prolonged.

### Third Embodiment

Next, a memory system according to a third embodiment will be described. Hereinafter, the differences from the first embodiment and the second embodiment will be mainly described.

In the first embodiment and the second embodiment, the configuration is illustrated in which the patrol cycle is variable according to the configuration information about mirroring, but in the third embodiment, a configuration will be illustrated in which each memory system 1 performs determination based on the most recent patrol time.

For example, since each of the memory systems 1_1 to 1_3 varies a patrol cycle according to the configuration information about mirroring, the timing of each of the memory systems 1_1 to 1_3 to execute the patrol process may differ from each other (see FIGS. 6 and 9).

Conversely, in the information processing system 200, each of the memory systems 1_1 to 1_3 may store, as patrol time information 16e, the time at which the most recent patrol process was performed in the storage unit 16. In the following description, the time at which the most recent patrol process was executed is referred to as the patrol time.

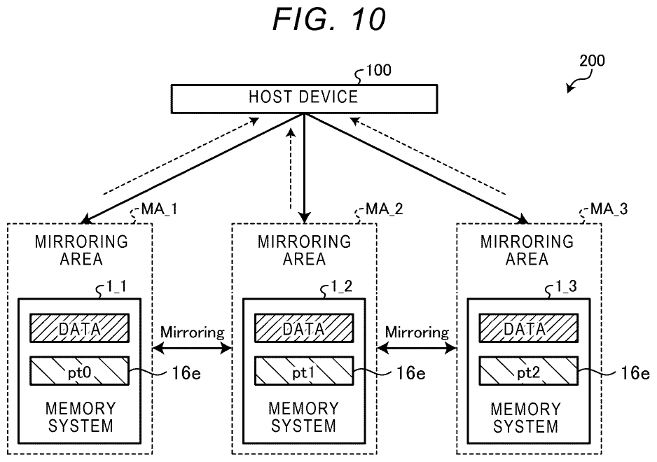

The host device 100 may broadcast an inquiry command to inquire whether the memory system is suitable for data reading to the plurality of memory systems 1_1 to 1_3, as indicated by a solid line arrow in FIG. 10. FIG. 10 is a diagram showing a configuration and operation of an information processing system including the memory system according to the third embodiment. In the example of FIG. 10, the memory systems 1_1, 1_2, and 1_3 store the patrol time information 16e indicating that their patrol times are pt0, pt1, pt2, respectively.

In response to receiving the inquiry command, each of the memory systems 1_1 to 1_3 accesses the storage unit 16, refers to the patrol time information 16e, and determines whether the patrol process is executed within a predetermined time from (i.e., the predetermined time before) the timing of reception. Each of the memory systems 1_1 to 1_3 may return a response according to the result of determination to the host device 100 as indicated by the dotted arrow in FIG. 10.

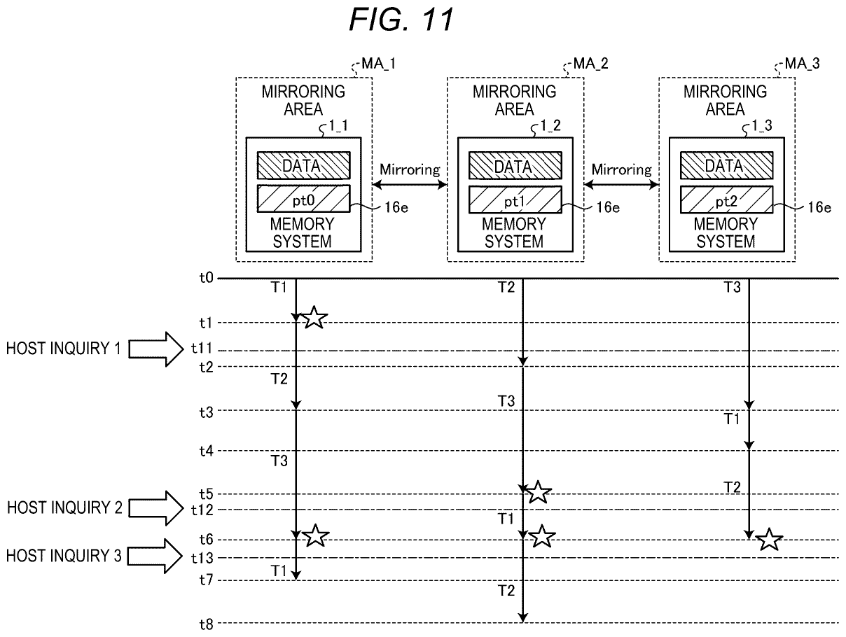

For example, in the example shown in the timing diagram of FIG. 11, the asterisks indicate the patrol times. FIG. 11 is a timing diagram showing the operation of the information processing system including the memory system according to the third embodiment. FIG. 11 shows that time elapses in the direction from t0 to t8.

At timing t11, when an inquiry command “host inquiry 1” is received from the host device 100, the memory system 1_1, which has performed patrol process at timing t1 within the predetermined time immediately prior, returns a response to the host device 100 indicating that it is the memory system suitable for data reading. The other memory systems 1_2 and 1_3, which have not executed the patrol process up to the timing t1 within the predetermined time immediately prior, return a response to the host device 100 indicating that it is not the memory system suitable for data reading.

At timing t12, when an inquiry command “host inquiry 2” is received from the host device 100, the memory system 1_2, which has performed patrol process at timing t5 within the predetermined time immediately prior, returns a response to the host device 100 indicating that it is the memory system suitable for data reading. The other memory systems 1_1 and 1_3, which have not executed patrol process up to the timing t5 within the predetermined time immediately prior, return a response to the host device 100 indicating that it is not the memory system suitable for data reading.

At timing t13, when an inquiry command “host inquiry 3” is received from the host device 100, each of the memory systems 1_1 to 1_3, which has performed patrol process at timing t6 within the predetermined time immediately prior, returns a response to the host device 100 indicating that it is the memory system suitable for data reading.

Consequently, the host device 100 can easily determine which memory system, among the plurality of memory systems 1_1 to 1_3, is suitable for data reading, thereby reducing its management load.

As described above, in the third embodiment, the memory system 1 stores the most recent patrol time and, in response to an inquiry from the host device 100, determines whether the memory system 1 is suitable for data reading based on the patrol time. As a result, the memory system 1 can appropriately determine whether it is suitable for data reading and respond to the host device 100 accordingly.

In addition to determining whether the patrol process has been executed within the predetermined time from the timing of reception of the inquiry, each memory system 1 may determine whether it is suitable for data reading by taking into account factors related to reliability and/or performance. The factors related to reliability and/or performance may include write/erase counts exceeding a predetermined number, the number of bad blocks exceeding a predetermined number, data retention characteristics deteriorating below a standard, and the like.

### Fourth Embodiment

Next, a memory system according to a fourth embodiment will be described. Hereinafter, the differences from the first embodiment and the third embodiment will be mainly described.

In the first embodiment and the second embodiment, the configuration is illustrated in which the patrol cycle is variable according to the configuration information about mirroring, but in the fourth embodiment, a configuration will be illustrated in which each memory system 1 shares its respective information about patrol time.

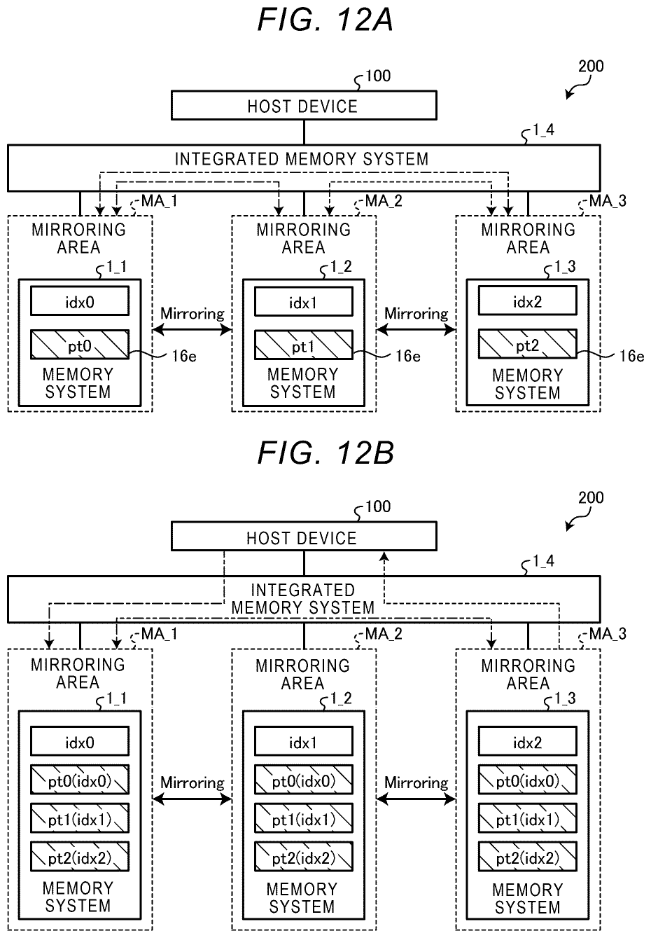

For example, as shown in FIG. 12, in the information processing system 200, a plurality of memory systems 1_1 to 1_3 may be connected to the host device 100 via an integrated memory system 1_4. FIG. 12 is a diagram showing a configuration and operation of the information processing system 200 including the memory system 1 according to the fourth embodiment. With this configuration, the plurality of memory systems 1_1 to 1_3 may exchange information with each other via the integrated memory system 1_4. The integrated memory system 1_4 is provided between the host device 100 and the plurality of memory systems 1_1 to 1_3. The integrated memory system 1_4 includes an interface circuit capable of communicating with the host device 100 and an interface circuit capable of communicating with the plurality of memory systems 1_1 to 1_3. That is, the integrated memory system 1_4 is an example of a relay device.

In the example of FIG. 12A, the plurality of memory systems 1_1 to 1_3 exchange the patrol time information 16e with each other through the integrated memory system 1_4.

As a result, the plurality of memory systems 1_1 to 1_3 share information in which the patrol times pt0, pt1, and pt2 are associated with each of the mirror indexes idx0, idx1, and idx2, as shown in FIG. 12B. Each of the memory systems 1_1 to 1_3 may refer to the shared information to determine which memory system 1 has the shortest elapsed time from the most recent patrol time and is therefore suitable for data reading.

In the example of FIG. 12B, the memory system 1_1 receives the host read command, but by referring to the shared information, it determines that the memory system 1_3 has the shortest elapsed time from the most recent patrol time and is therefore suitable for data reading. Accordingly, the memory system 1_1 transfers the host read command to the memory system 1_3 via the integrated memory system 1_4. In response to the host read command, the memory system 1_3 reads data and returns the data to the host device 100 via the integrated memory system 1_4.

As described above, in the fourth embodiment, in the memory system 1, the information about patrol time of each of the memory systems 1_1 to 1_3 is shared. Consequently, the command from the host device 100 such as the host read command may be transferred to the appropriate memory system 1, thereby improving the overall performance of the information processing system 200.

### Fifth Embodiment

Next, a memory system according to a fifth embodiment will be described. Hereinafter, the differences from the first embodiment and the fourth embodiment will be mainly described.

In the fourth embodiment, the configuration is illustrated in which the command from the host device 100 is transferred to the appropriate memory system 1 via the integrated memory system 1_4, but in the fifth embodiment, a configuration will be illustrated in which an appropriate memory system 1 selectively responds to the host device 100 with respect to the command from the host device 100.

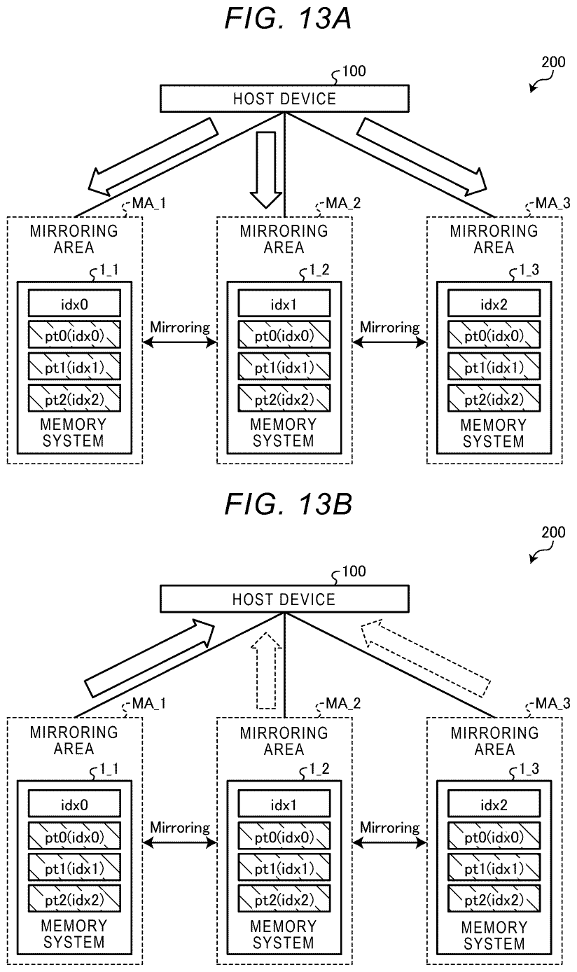

For example, as indicated by solid white arrows in FIG. 13A, the host read command may be broadcasted from the host device 100 to each of the memory systems 1_1 to 1_3 to be mirrored.

At this time, it is assumed that the plurality of memory systems 1_1 to 1_3 share information in which the patrol times pt0, pt1, and pt2 are associated with each of the mirror indexes idx0, idx1, and idx2. Each of the memory systems 1_1 to 1_3 may refer to the shared information to determine which memory system 1 has the shortest elapsed time from the most recent patrol time and is therefore suitable for data reading.

In the example of FIG. 13B, when the memory system 1_1 receives the host read command, the memory system 1_1 refers to the shared information and determines that the memory system 1_1, among the memory systems 1_1 to 1_3 to be mirrored, has the shortest elapsed time from the most recent patrol time and is therefore suitable for data reading. Accordingly, in response to the host read command, the memory system 1_1 reads data and returns the data to the host device 100 as indicated by a solid white arrow in FIG. 13B.

On the other hand, the memory systems 1_2 and 1_3 receive the host read command, the memory systems 1_2 and 1_3 refer to the shared information, but determine that the other memory system 1_1 has the shortest elapsed time from the most recent patrol time and is therefore suitable for data reading. Accordingly, in response to the host read command, the memory systems 1_2 and 1_3 return responses that do not include data to the host device 100 as indicated by dotted white arrows in FIG. 13B.

As described above, in the fifth embodiment, the memory system 1 selectively returns data in response to the command from the host device 100, when the memory system 1 is an appropriate memory system. Consequently, the amount of data returned from the plurality of memory systems 1_1 to 1_3 to the host device 100 can be saved, and the communication bandwidth between the host device 100 and each of the memory systems 1_1 to 1_3 can be allocated.

### Sixth Embodiment

Next, a memory system according to a sixth embodiment will be described. Hereinafter, the differences from the first embodiment and the fifth embodiment will be mainly described.

In the first to fifth embodiments, the configuration is illustrated in which the patrol cycle is variable in units of memory systems 1, but in the sixth embodiment, a configuration will be illustrated in which the patrol cycle is variable in units smaller than the memory system 1.

In each memory system 1, the memory cell array 61 of the nonvolatile memory 6 includes a plurality of physical blocks BLK, but data characteristics (e.g., data size, access frequency) of the plurality of physical blocks BLK are not uniform, and exhibit a certain degree of variation. Therefore, by grouping and managing a plurality of physical blocks BLK according to data characteristics, efficient management can be achieved.

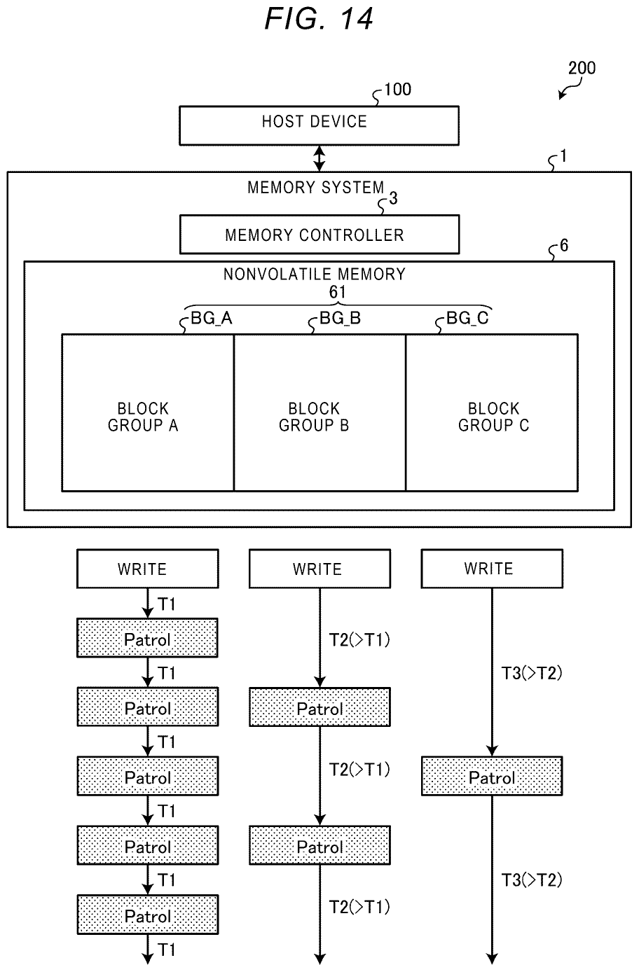

For example, the interior of the memory cell array 61 of each memory system 1 may be grouped into a plurality of block groups BG_A, BG_B, and BG_C as shown in FIG. 14. FIG. 14 is a diagram showing a configuration and operation of an information processing system including the memory system according to the sixth embodiment. In this case, in each memory system 1, the patrol cycle may be variable for each block group BG.

For example, when access frequencies are higher in the order of block groups BG_A, BG_B, and BG_C, the memory controller 3 may set the patrol cycles of the block groups BG_A, BG_B, and BG_C to T1, T2 (>T1), and T3 (>T2), respectively. As a result, the frequency of the patrol cycle can be matched to the access frequency, and the load of the patrol process can be efficiently reduced.

As described above, in the sixth embodiment, in the memory system 1, the patrol cycle is made variable in units grouped according to data characteristics. Consequently, the load of patrol process can be efficiently reduced.

### Seventh Embodiment

Next, a memory system according to a seventh embodiment will be described. Hereinafter, the differences from the first embodiment and the sixth embodiment will be mainly described.

In the sixth embodiment, the configuration is illustrated in which the patrol cycle is variable in units smaller than the memory system 1, and in the seventh embodiment, an embodiment for implementing the configuration is illustrated.

For example, in order to manage the plurality of block groups BG_A, BG_B, and BG_C in the memory cell array 61 of each memory system 1, it may be contemplated to use a placement ID used in a flexible data placement technique. The placement ID is information used to bundle data.

Each memory system 1 may store ID management information 16f in the storage unit 16. The ID management information 16f is information in which the block group ID and the placement ID are associated with each other. The ID management information 16f may be implemented in a table format as shown in FIG. 15. The ID management information 16f includes a block group ID field 16f1 and a placement ID field 16f2.

By referring to the ID management information 16f, the placement ID corresponding to the block group ID can be determined. For example, it can be determined that a block group ID “BG_A” corresponds to a placement ID “pid0”.

At this time, each memory system 1 may store, in the storage unit 16, patrol cycle management information 16aj in association with the placement ID in place of the mirror index idx. In the patrol cycle management information 16aj, the configuration information about mirroring, the placement ID, and the information about patrol cycle are associated with a plurality of combinations of configuration information and placement ID.

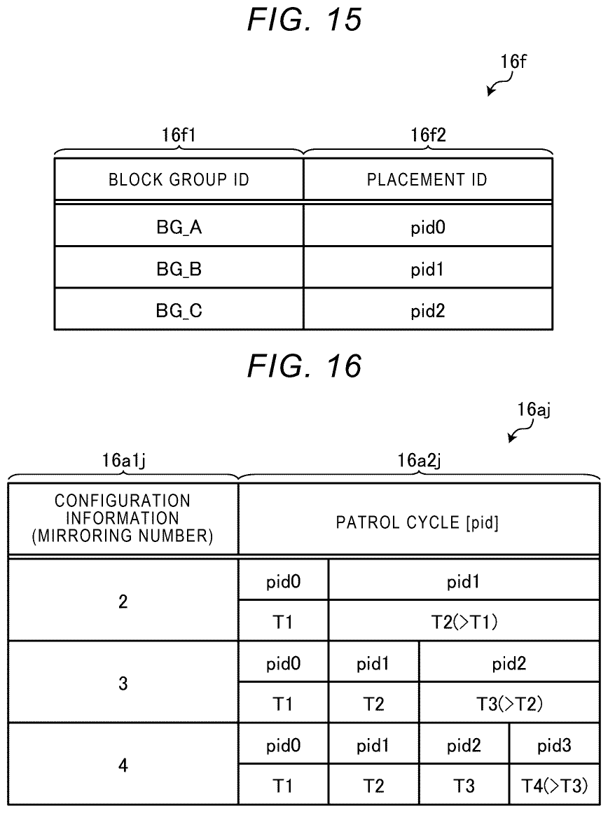

The patrol cycle management information 16aj may be implemented in a table format as shown in FIG. 16. FIG. 16 is a diagram showing a data structure of the patrol cycle management information 16aj in the seventh embodiment.

The patrol cycle management information 16aj shown in FIG. 16 includes a configuration information field 16a1j and an array field 16a2j. In the configuration information field 16a1j, the configuration information about mirroring is recorded. For example, the mirroring number is recorded. An array “patrol cycle [pid]” is recorded in the array field 16a2j. The array “patrol cycle [pid]” is an array that returns a patrol cycle T when a placement IDpid is given.

By referring to the patrol cycle management information 16aj, when the mirroring number is “2”, it can be seen that the patrol cycle for the placement IDpid0 is T1. It can also be seen that the patrol cycle for the placement IDpid1 is T2 (>T1).

By referring to the patrol cycle management information 16aj, when the mirroring number is “3”, it can be seen that the patrol cycle for the placement IDpid0 is T1. It can be seen that the patrol cycle for the placement IDpid1 is T2. It can also be seen that the patrol cycle for the placement IDpid2 is T3 (>T2).

By referring to the patrol cycle management information 16aj, when the mirroring number is “4”, it can be seen that the patrol cycle for the placement IDpid0 is T1. It can be seen that the patrol cycle for the placement IDpid1 is T2. It can be seen that the patrol cycle for the placement IDpid2 is T3. It can also be seen that the patrol cycle for the placement IDpid3 is T4 (>T3).

The shortest patrol cycle T1 in the patrol cycle management information 16aj may be a predetermined default patrol cycle to ensure data reliability of the memory system 1_1. Each of the other patrol cycles T2 to T4 may be an integer multiple of the patrol cycle T1.

The patrol cycle management information 16aj may be implemented in a format other than the table format when the configuration information about mirroring, the placement ID, and the information about patrol cycle are associated with a plurality of combinations of configuration information and placement ID. The patrol cycle management information 16aj may be implemented in a form of a function expression that returns a patrol cycle when the configuration information about mirroring and the placement ID are input. The information about patrol cycle may be provided as a difference from the default patrol cycle, rather than the patrol cycle.

As described above, in the seventh embodiment, the placement ID corresponding to the block group ID can be determined using the ID management information 16f, and the patrol cycle corresponding to the configuration information (the mirroring number) and the placement ID may be specified by the patrol cycle management information 16aj. Consequently, the patrol cycle may be varied on a block group basis.

### Eighth Embodiment

Next, a memory system according to an eighth embodiment will be described. Hereinafter, the differences from the first embodiment and the seventh embodiment will be mainly described.

In the sixth embodiment, the configuration is illustrated in which the patrol cycle is variable in units smaller than the memory system, and in the eighth embodiment, a configuration for managing the units smaller than the memory system is illustrated.

When managing units smaller than the memory system, the size of the unit to be managed may vary depending on the content to be managed. For example, while metadata is basically managed for each block, parameters common to the block group may be stored in units of the block groups, and information that does not need to be managed at the block level may be aggregated into management information in units of the block groups.

Based on such an idea, each memory system 1 may store block group management information 16g and block management information 16h in the storage unit 16.

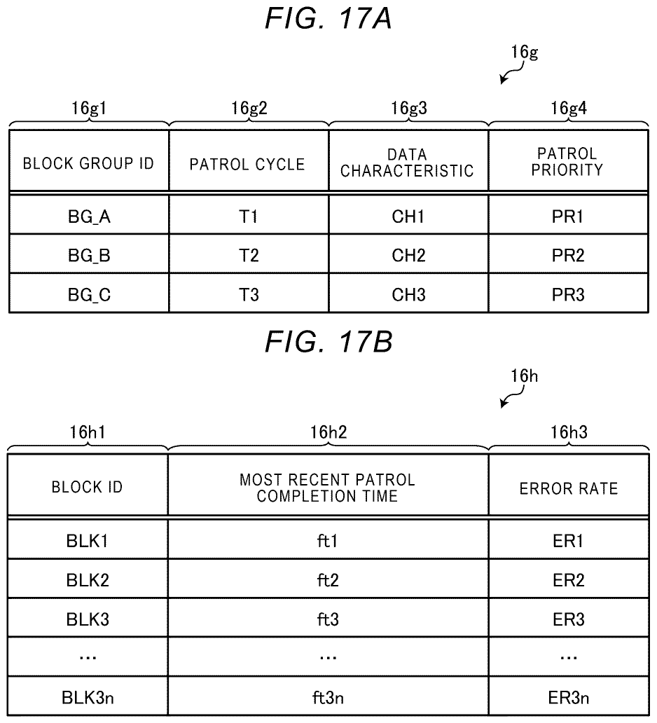

The block group management information 16g may be information in which a block group ID, a patrol cycle, data characteristics, and patrol priority are associated with a plurality of block group IDs. The patrol priority may be determined according to, for example, data characteristics. The block group management information 16g may be implemented in a table format as shown in FIG. 17A. The block group management information 16g includes a block group ID field 16g1, a patrol cycle field 16g2, a data characteristic field 16g3, and a patrol priority field 16g4. The data characteristic is stored in the data characteristic field 16g3, and the patrol priority is stored in the patrol priority field 16g4.

The block management information 16h may be information in which a block ID, a most recent patrol completion time, and an error rate are associated with a plurality of block IDs. The most recent patrol completion time is the time at which the previous patrol process for the block of the corresponding block ID is completed. The error rate may be the worst error rate as a result of the read process in the previous patrol. The block management information 16h may be implemented in a table format as shown in FIG. 17B. The block management information 16h includes a block ID field 16h1, a most recent patrol completion time field 16h2, and an error rate field 16h3. The most recent patrol completion time field 16h2 stores the most recent patrol completion time, and the error rate field 16h3 stores the error rate.

As described above, in the eighth embodiment, the size of the unit to be managed is varied depending on the content to be managed in the memory system 1. For example, the patrol cycle is managed in block group units, and the most recent patrol completion time is managed in block units. Consequently, the information that does not need to be managed at each block level can be aggregated into the management information about block group, thereby preventing the amount of metadata to be managed from becoming excessively large.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a nonvolatile memory including a first memory region;
a host interface connectable to a host and configured to receive mirroring information from the host, the mirroring information indicating: i) a number of mirroring regions assigned by the host for performing a mirroring operation to redundantly store data at least in the first memory region and a second memory region that is within or out of the memory system; and ii) an identifier of a mirroring region assigned to the first memory region; and
a controller configured to:
maintain patrol cycle information indicating a patrol cycle with respect to an identifier of each of mirroring regions for each of different numbers of mirroring regions;
upon receiving the mirroring information from the host via the host interface, set a patrol cycle for the first memory region with reference to a part of the patrol cycle information corresponding to the number of mirroring regions and the identifier indicated by the mirroring information from the host; and
perform a patrol process with respect to the first memory region at the set patrol cycle, the patrol process comprising reading of data from the first memory region and then writing of the read data into another memory region after error correction included in the read data.

2. The memory system according to claim 1, wherein
the patrol cycle information maintained by the controller indicates that a first patrol cycle for a first identifier and a second patrol cycle longer than the first cycle for a second identifier, and
the controller is configured to set the patrol cycle for the first memory region to be the first patrol cycle when the identifier indicated by the mirroring information from the host is the first identifier, and to be the second patrol cycle when the identifier indicated by the mirroring information from the host is the second identifier.

3. The memory system according to claim 1, wherein a patrol cycle corresponding to an identifier and a number of mirroring regions indicated by the patrol cycle information comprises a plurality of different patrol cycles corresponding to different cycles of the patrol process.

4. The memory system according to claim 3, wherein the plurality of different patrol cycles corresponding to the different cycles of the patrol process comprises a first patrol cycle for a first cycle of the patrol process and a second patrol cycle different from the first patrol cycle for a second cycle of the patrol process.

5. The memory system according to claim 4, wherein the plurality of different patrol cycles corresponding to the different cycles of the patrol process further comprises a third patrol cycle different from the first patrol cycle and the second patrol cycle for a third cycle of the patrol process.

6. The memory system according to claim 1, wherein the controller is configured to retain a time when a most recent patrol process with respect to the first memory region has been performed, and transmit information about the most recent patrol process to the host.

7. The memory system according to claim 6, wherein the information about the most recent patrol process indicates that the first memory region is suitable for data reading when the retained time is within a predetermined range from a current time, and that the first memory region is not suitable for the data reading when the retained time is not within the predetermined range from the current time.

8. The memory system according to claim 1, wherein the second memory region is out of the memory system.

9. The memory system according to claim 1, wherein the second memory region is within the nonvolatile memory.

10. The memory system according to claim 9, wherein
the host interface is configured to receive second mirroring information from the host, the second mirroring information indicating: i) the number of mirroring regions assigned by the host for performing the mirroring operation; and ii) a second identifier of a mirroring region assigned to the second memory region, and
the controller is configured to:
upon receiving the second mirroring information from the host via the host interface, set a second patrol cycle for the second memory region with reference to a part of the patrol cycle information corresponding to the number of mirroring regions and the second identifier indicated by the second mirroring information from the host; and
perform a second patrol process with respect to the second memory region at the set second patrol cycle.

11. The memory system according to claim 9, wherein the nonvolatile memory includes a first group of blocks as the first memory region and a second group of blocks as the second memory region.

12. An integrated memory system comprising a plurality of memory systems, each of the memory systems connectable to a host and comprising:
a nonvolatile memory including a memory region;
an interface configured to receive mirroring information from the host, the mirroring information indicating: i) a number of mirroring regions assigned by the host for performing a mirroring operation to redundantly store data in the memory region of the plurality of memory systems; and ii) an identifier of a mirroring region assigned to the memory region of its own memory system; and
a controller configured to:
maintain patrol cycle information indicating a patrol cycle with respect to an identifier of each of mirroring regions for each of different numbers of mirroring regions;
upon receiving the mirroring information from the host via the host interface, set a patrol cycle for the memory region of its own memory system with reference to a part of the patrol cycle information corresponding to the number of mirroring regions and the identifier indicated by the mirroring information from the host; and
perform a patrol process with respect to the memory region of its own memory system at the set patrol cycle, the patrol process comprising reading of data from the memory region of its own memory system and then writing of the read data into another memory region of its own memory system after error correction included in the read data.

13. The integrated memory system according to claim 12, further comprising:
a relay device connectable between the host and the plurality of memory systems, wherein
in each of the plurality of memory systems, the controller is configured to retain a time when a most recent patrol process with respect to the memory region of its own memory system has been performed, and transmit information about the retained time about the most recent patrol process to other one or more of the plurality of memory systems via the relay device.

14. The integrated memory system according to claim 13, wherein
in each of the plurality of memory systems, the controller is configured to receive a time when a most recent patrol process with respect to the memory region of other one of the plurality of memory systems has been performed.

15. The integrated memory system according to claim 14, wherein in each of the plurality of memory systems, the controller is configured to determine whether the memory region of its own memory system is suitable for data reading based on the retained time and the received time, in response to a read command from the host via the relay device.

16. The integrated memory system according to claim 15, wherein in each of the plurality of memory systems, the controller is configured to:
return, to the host via the relay device, data read from the memory region of its own memory system when determining that the memory region of its own memory system is suitable for the data reading; and
transfer, to another one of the plurality of memory systems via the relay device, the read command when the memory region of its own memory system is not suitable for the data reading.

17. The integrated memory system according to claim 15, wherein in each of the plurality of memory systems, the controller is configured to:
return, to the host via the relay device, data read from the memory region of its own memory system when determining that the memory region of its own memory system is suitable for the data reading; and
return, to the host via the relay device, a response including no data read from the memory region of its own memory system when determining that the memory region of its own memory system is not suitable for the data reading.

18. A method of controlling a memory system including a nonvolatile memory having a first memory region, and a host interface connectable to a host, the method comprising:
maintaining patrol cycle information indicating a patrol cycle with respect to an identifier of each of mirroring regions for each of different numbers of mirroring regions;
receiving, from the host via the host interface, mirroring information indicating: i) a number of mirroring regions assigned by the host for performing a mirroring operation to redundantly store data at least in the first memory region and a second memory region that is within or out of the memory system; and ii) an identifier of a mirroring region assigned to the first memory region;
upon receiving the mirroring information from the host via the host interface, setting a patrol cycle for the first memory region with reference to a part of the patrol cycle information corresponding to the number of mirroring regions and the identifier indicated by the mirroring information from the host; and
performing a patrol process with respect to the first memory region at the set patrol cycle, the patrol process comprising reading of data from the first memory region and then writing of the read data into another memory region after error correction included in the read data.

19. The method according to claim 18, wherein a patrol cycle corresponding to an identifier and a number of mirroring regions indicated by the patrol cycle information comprises a plurality of different patrol cycles corresponding to different cycles of the patrol process.

20. The method according to claim 18, further comprising retaining a time when a most recent patrol process with respect to the first memory region has been performed, and transmitting information about the most recent patrol process to the host.
